(19) United States
(12) Patent Application Publication
(10) Pub. No.: US 2008/0238643 A1
(43) Pub. Date: Oct. 2, 2008

(54) CARGO CARRIER SENSOR SYSTEM

(76) Inventor: Peter F. Malen, Salt Lake City, UT (US)

Correspondence Address: WORKMAN NYDEGGER, 60 EAST SOUTH TEMPLE, 1000 EAGLE GATE TOWER, SALT LAKE CITY, UT, 84111, US

(21) Appl. No.: 12/054,942

(22) Filed: Mar. 25, 2008

Related U.S. Application Data
(60) Provisional application No. 60/908,333, filed on Mar. 27, 2007.

(51) Int. Cl. B60Q 1/00

(52) U.S. Cl. 340/438

(57) ABSTRACT

A cargo carrier sensor system including a sensor configured for wireless communication with an associated indicator. The sensor can be attached to rooftop cargo and/or an associated cargo carrier. A detection signal is generated and transmitted by the sensor. When the sensor detects the presence of an obstacle, the sensor transmits a corresponding obstacle signal to the indicator. In response to the obstacle signal, the indicator generates a corresponding warning that is perceptible by an operator of the vehicle upon which the rooftop cargo is positioned.

### RELATED APPLICATIONS

This application claims the benefit of U.S. Provisional Patent application Ser. No. 60/908,333, entitled CARGO CARRIER SENSOR SYSTEM, filed Mar. 27, 2007, and incorporated herein in its entirety by this reference.

### BACKGROUND OF THE INVENTION

1. Field of the Invention

The present invention relates generally to rooftop cargo carriers, racks and boxes. More particularly, example embodiments of the invention concern sensors and related systems and components for warning a vehicle operator of obstacles that could damage cargo and other materials carried on the rooftop of the vehicle.

2. Related Technology

Motor vehicles, even if moving slowly, can present a significant hazard to pedestrians, other vehicles, and property. One contributing factor in many accidents is the fact that the operator of the vehicle often does not have access to reliable information about the existence and/or location of obstructions that may be near the vehicle. For example, mirrors are useful in helping a driver avoid obstructions, but even vehicles with multiple mirrors may nonetheless have blind spots or areas near the vehicle that are not visible to the operator. Moreover, it is often the case that the operator of the vehicle must work alone and cannot rely on aid from another person in identifying potential obstructions.

In light of concerns such as these, various systems and components have been devised to warn vehicle operators of potentially dangerous conditions. For example, some warning systems and devices are concerned with providing a warning to those who may be in the path of the vehicle. In particular, these types of systems may involve the use of audible and/or visual warning signals to warn pedestrians or other vehicle operators, for example, of the impending or actual motion of the vehicle with which the warning system is associated. In this way, a person perceiving the vehicle warning signal is able to move to a safe position, relative to the moving vehicle, and thereby avoid being struck by the vehicle. Thus, the focus of these types of warning systems is to warn those who may be in or near the path of the vehicle.

In an alternative approach, yet other warning systems are configured and arranged, instead, to warn the vehicle operator of a potential hazard. For example, some vehicles include sensors located at or near the rear of the vehicle to warn the operator, by way of an audible signal for example, if the vehicle should back too close to an obstacle such as another vehicle or a person for example. In this way, the operator is able to take corrective action, such as stopping or slowing the vehicle, before a collision or other incident occurs. Thus, the focus of this type of system is to warn the vehicle operator, rather than those who may be in or near the path of the vehicle.

The sensors employed in arrangements of this type and others generally only provide information concerning obstacles located near the back of the vehicle. There is no need for sensors or detection capability in the front portion of the vehicle since the operator has a relatively good field of vision in that area and is generally able to perceive pedestrians, vehicles or objects that may be in the intended path of the vehicle.

A related concern with sensor systems such as those just described is that they are somewhat inflexible in terms of their configuration. In particular, the sensors are intended to be fixed in a particular location and generally cannot be readily relocated to another position in relation to the vehicle. Moreover, relocation of the sensors in these systems would likely prove to be problematic, since changes to the location of the sensors could impair the operation and effectiveness of the system.

Another area of concern relates to car top cargo carriers, car top cargo boxes, and car top racks for equipment such as bicycles, skis, kayaks and snowboards. In particular, such racks and/or the equipment that is stowed in them often significantly extend the height of the vehicle on which they are mounted. Thus, garages and other structures that would provide adequate clearance for a vehicle without racks pose a significant hazard for vehicles with car top cargo.

That is, if a vehicle operator should happen to forget that a bicycle, for example, is attached to a rack on the top of the vehicle, the operator may drive the vehicle into a parking area or garage without adequate clearance to accommodate the mounted bicycle. Even if the vehicle is traveling relatively slowly, significant damage can occur to the garage, the bicycle, the associated rack, and/or to the vehicle itself. Similar problems may arise with other car top cargo carriers, racks and equipment.

While the damage that may result from arrangements such as those just described can be quite significant, particularly in view of the costs associated with high end equipment such as bicycles and kayaks for example, vehicle operators generally do not have timely access to reliable information that would enable them to avoid such collisions. Instead, the operator typically must rely solely on his memory and hope that he will recall the mounted equipment in time to avoid a collision. For most vehicle operators however, this is a less than ideal system for avoiding damage to car top cargo.

Some vehicle operators may employ techniques such as tying a brightly colored ribbon to the cargo rack as a reminder that there is equipment mounted on the car top. Yet other vehicle operators hope to rely on their memory to remind them that equipment is positioned on the top of their vehicle. However, pulling a vehicle into a structure such as a garage is a routine undertaking that is typically performed with little or no thought and vehicle operators can easily overlook a passive reminder such as a ribbon when performing this act. Similarly, vehicle operators commonly forget that there is equipment positioned on the car top.

Other sensor systems include sensors mounted in the front bumper of a vehicle. However, the focus of these types of systems is to assist in parking of the vehicle. Because these sensor systems include sensors that are mounted low on the vehicle, such as in the bumpers, these systems are inadequate to warn a vehicle operator of an impending collision between rooftop cargo and a low hanging obstacle.

In view of the foregoing, and other, problems in the art, it would be useful to provide a system that would provide vehicle operators with timely access to reliable information regarding obstructions that pose a threat of damage to roof mounted cargo.

### BRIEF SUMMARY OF AN EXAMPLE EMBODIMENT OF THE INVENTION

In general, embodiments of the invention are concerned with sensors and related systems and components for warning a vehicle operator of obstacles that could damage cargo and other materials carried on the rooftop of the vehicle.

In one example embodiment, a sensor is provided whose location is modifiable with respect to an associated cargo carrier. The sensor is configured for communication with a remote indicator that can be positioned inside a vehicle with which the cargo carrier is associated. The remote indicator is responsive to the sensor and provides a perceptible indication to an occupant of the vehicle upon receipt of a signal from the sensor.

### BRIEF DESCRIPTION OF THE DRAWINGS

In order that the manner in which the above-recited and other advantages and features of the invention are obtained, a more particular description of the invention briefly described above will be rendered by reference to specific embodiments thereof which are illustrated in the appended drawings. Understanding that these drawings depict only typical embodiments of the invention and are not therefore to be considered limiting of its scope, the invention will be described and explained with additional specificity and detail through the use of the accompanying drawings in which:

FIGS. 1a and 1b are side views of an example operating environment and example sensor system configuration;

FIGS. 2a through 2c are examples of cargo carriers in connection with which embodiments of the invention may be employed;

FIG. 3 discloses aspects of an example sensor and associated sensor harness;

FIG. 4 discloses aspects of an example sensor system; and

FIG. 5 is a block diagram disclosing various aspects of example circuits that may be used in a sensor and/or sensor system.

### DETAILED DESCRIPTION OF SOME EXAMPLE EMBODIMENTS OF THE INVENTION

Reference will now be made to the drawings to describe various aspects of example embodiments of the invention. It should be understood that the drawings are diagrammatic and schematic representations of such example embodiments and, accordingly, are not limiting of the scope of the present invention, nor are the drawings necessarily drawn to scale.

Generally, embodiments of the invention are concerned with sensors and related systems and components for warning a vehicle operator of obstacles that could damage cargo and other materials carried on the rooftop of the vehicle.

### I. Example Operating Environments

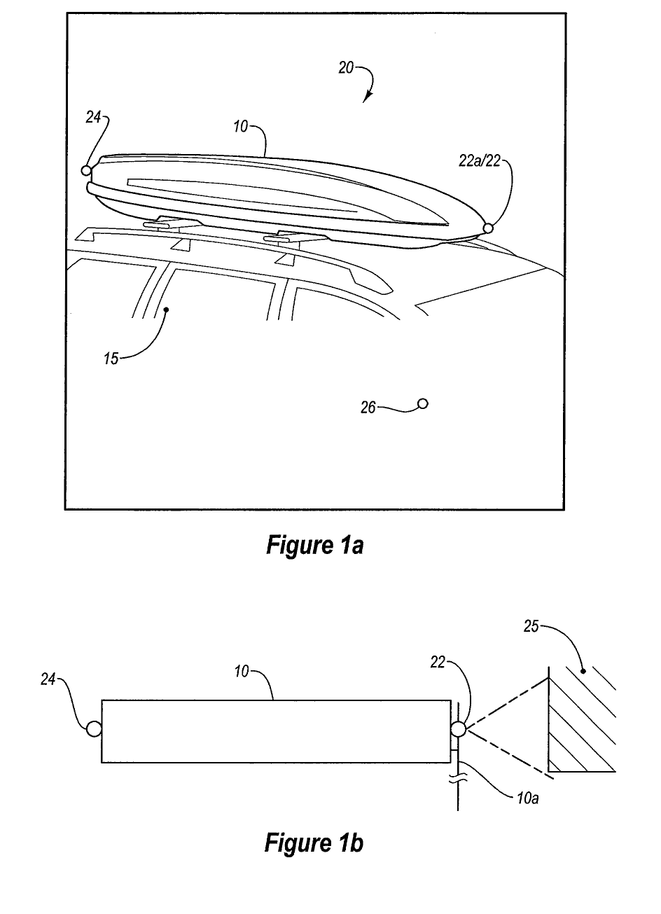

Directing attention now to FIGS. 1a-1b, details are provided concerning an example of a cargo carrier 10, suitable for use in securing and transporting vehicle rooftop cargo, and a sensor system 20 suitable for use with the cargo carrier 10 that is attached to a vehicle 15. The rooftop cargo carrier 10 can be any structure(s) that are mounted or otherwise attached, either permanently or detachably, to a vehicle and that are configured to permit securement of cargo on or near the top of the vehicle. Such rooftop cargo carriers include, but are not limited to, bins, boxes, pods, carriers and racks, or any other structures adapted, or adaptable, to enable the securement of cargo on or near the top of a vehicle, and the release of the cargo when it is desired to remove the cargo from the rooftop. As suggested by the foregoing, the disclosed rooftop cargo carriers comprise example structural implementations of a means for securing cargo. Thus, any other structures of comparable functionality may likewise be employed, and are contemplated as falling within the scope of the invention. Correspondingly, the scope of the invention should not be construed to be limited to any particular configuration of a cargo carrier.

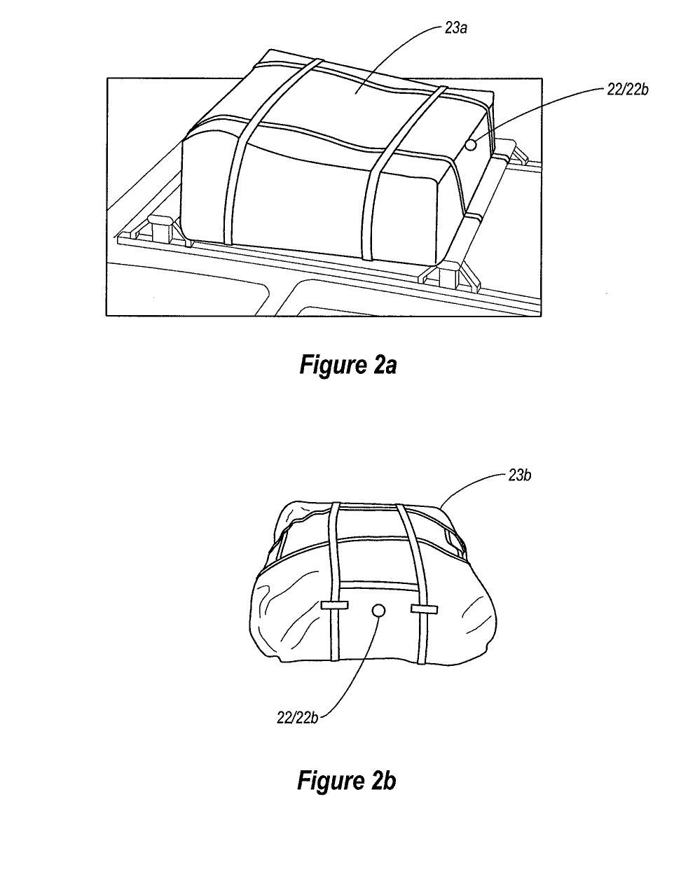

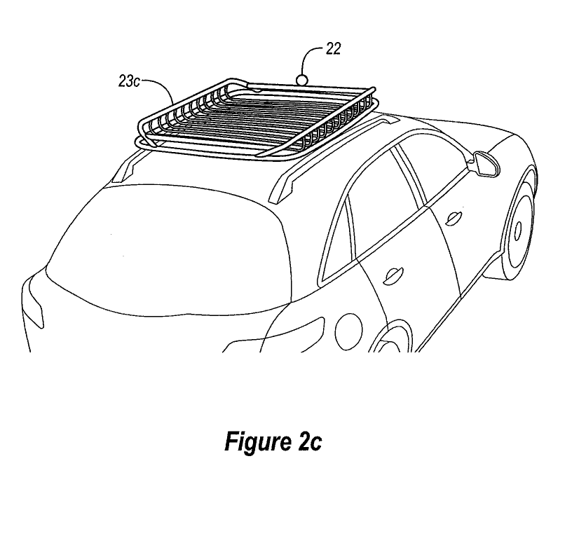

The size, shape and construction of rooftop cargo carriers may vary as well. Examples of some cargo carrier configurations in connection with which embodiments of the invention may be employed are disclosed in FIGS. 2a through 2c, as well as in FIGS. 1a-1b.

Further, such carriers can be configured for general, or specific, use depending upon the needs of the user. By way of example, cargo carriers such as specialized racks are available that are configured for equipment as diverse as kayaks, canoes, skis, snowboards, bicycles and windsurfers. Yet other cargo carriers such as cargo pods and general purpose racks can be used to carry virtually anything that will fit, such as, but not limited to, luggage, camping equipment, building materials, landscaping materials. Still other cargo carriers include basic components, such as a rack for example, that can be combined with different sets of various specialized components such that the resulting cargo carrier is then adapted for a specific type of cargo.

As the foregoing makes clear, embodiments of the invention are not limited for use in connection with any particular type of cargo carrier or any particular type of cargo. Correspondingly, embodiments of the invention are not constrained for use with any particular type of vehicle.

With continued attention to FIGS. 1a-1b, the sensor system 20 includes at least one sensor 22, and may also include a second sensor 24 and one or more additional sensors. In general, the sensors 22 and/or 24 serve to warn a vehicle operator of a potential collision with an obstruction 25. In the disclosed example, the sensor 22 is located at or near the front of the cargo carrier 10. If included, the sensor 24 may be located at or near the rear of the cargo carrier 10. The sensor 24, for example, may be useful in situations where a vehicle operator has a need to operate the vehicle in reverse gear while cargo is positioned on or near the top of the vehicle. Further information concerning some example sensors is disclosed elsewhere herein. Finally, the sensors 22 and/or 24 may or may not each be positioned within a respective housing, or other suitable device, that may or may not be integral with a cargo carrier.

In the disclosed example, the sensor system 20 also includes one or more remote indicators 26 located so as to be perceptible by a vehicle operator, such as inside the vehicle for example. While the illustrated example includes one or more sensors 22, any other type of sensor capable of implementing aspects of the functionality disclosed herein may alternatively be employed.

The sensor system 20 can be configured in various ways with respect to the cargo carrier 10. In some example embodiments, the sensor 22 is configured and arranged such that the location of the sensor 22 relative to the cargo carrier is substantially fixed. In one particular example of such a configuration, the sensor system 20 is employed in connection with a cargo carrier 10 that is implemented so that regardless of whether cargo is positioned in/on the cargo carrier, it is the cargo carrier, rather than the cargo, that defines the forward-most and rearward-most extents of the cargo and cargo carrier. Some examples of this type of cargo carrier include, but are not limited to, cargo ‘pods’ such as those manufactured by Thule® and Yakima® (see, e.g., FIGS. 1a-1b).

In this example, the sensor 22, and any other sensors that may be provided, can be positioned within a housing 22a, or respective housings or other structures, that is/are integral with, or otherwise attached to, the cargo carrier. The sensor 22 can be removed from the housing for service and/or replacement. In this example, the sensor 22 can be positioned at or near the forward-most portion of the cargo carrier. Correspondingly, the sensor 24, if provided, can be positioned at or near the rearward-most portion of the cargo carrier. Of course, other locations and sensors may alternatively be employed, and the scope of the invention is not limited to any particular number, orientation, type, or arrangement of sensors. In some cases, one or more sensors 22, for example, can be mounted to the vehicle 15 at a location proximate the forward-most end of the cargo carrier, and/or in another desired location.

As another example, and as indicated in FIG. 1b, the cargo carrier 10 may include a sensor positioning device 10a that is permanently, or removably, attached to the cargo carrier 10. The sensor positioning device 10a may alternatively be attached, either permanently or removably, to the vehicle associated with the cargo carrier 10. In one example implementation, one or more sensors 22 are slidingly attached to the sensor positioning device 10a so that the vertical location of the sensor(s) 22 relative to the cargo carrier 10 can be adjusted by moving the sensor(s) 22 up, or down, the sensor positioning device 10. In this way, the sensor(s) 22 can be positioned at the maximum height of the cargo carrier 10.

The sensor positioning device 10a can take any form that is suited to implement one or more aspects of the aforementioned functionalities. In one example, the sensor positioning device 10a includes a track which slidingly retains a portion of a structure, such as a housing for example, to which the sensor(s) is/are attached, such that movement of the sensor(s) 22 relative to the sensor positioning device 10a is constrained to the vertical direction. An element such as a bolt or screw can be used to releasably retain the sensor(s) 22 in the desired vertical position.

As another example, the sensor positioning device 10a may include a track that includes engagement elements, such as teeth, slots or other elements, and within which a biasing element is disposed. In this example, the sensor(s) 22 are disengaged from the engagement elements by pushing the sensor(s) 22 down into the track so as to overcome the bias imposed by the biasing element. Thus situated, the sensor(s) 22 can then be moved to the desired position and, when the desired position is reached, the pressure on the sensor(s) 22 is released, allowing the biasing element to push the sensor(s) 22 back into engagement with the engagement elements of the track. In this way, the sensor(s) 22 is/are moved to, and then retained in, the desired position.

In yet another example embodiment, the sensor 22 is attached to the cargo carrier, but is not integral with the cargo carrier. In one example of such an arrangement, the sensor 22 can be removably attached to the cargo carrier at any of a number of different locations.

In another example arrangement, the sensor 22 can be employed in connection with soft cargo carriers that employ a soft or semi-rigid cover, made of rubber, plastic, nylon, vinyl or other materials, that can be attached to a rack or bin mounted to the roof of the vehicle, or that can be attached directly to the vehicle itself by straps, cords, cables and/or other devices. Examples of such soft cargo carriers are disclosed in FIGS. 2a and 2b. In this example, the sensor 22 can be positioned within a housing 22b that is permanently, or removably, attached to the cover 23a or 23b. The sensor 22 can be removed from the housing for service and/or replacement. In this embodiment, as in all other embodiments disclosed herein, multiple sensors at various locations can be employed. In yet another example, aspects of which are disclosed in FIG. 2c, a sensor 22 is attached to a cargo carrier 23c implemented in the form of a general purpose rack/bin configuration.

While it may be desirable in some applications to locate one or more sensors at or near the furthest forward and/or rear extents of the cargo, the scope of the invention is not so limited. Thus, in some examples, one or more sensor(s) can be located on the cargo carrier itself, notwithstanding that cargo associated with the cargo carrier may extend some distance beyond the forward-most and/or rearward-most portion(s) of the cargo carrier.

In yet another example embodiment of the sensor system 20, the sensor 22, and any other sensors that may be employed, are configured to be removably attached to a cargo carrier and/or to the associated cargo. One useful aspect of this configuration is that the sensor system 20 can be employed with virtually any combination of cargo and cargo carrier and thus possesses a high degree of flexibility and adaptability in terms of the ability of the sensor system 20 to accommodate cargo and cargo carriers of various sizes and/or configurations. In general, the sensor 22 can be employed in connection with any structure(s) or device(s) that permit the sensor 22 to be removably positioned on cargo and/or a cargo carrier.

In this example embodiment, as in other examples where the sensor is removably attachable to cargo and/or a cargo carrier, the sensor and/or associated devices, such as the harness discussed below for example, may include a lock or other locking device to prevent removal of the sensor from the cargo and/or cargo carrier.

By way of example, and not limitation, the sensor 22 may be positioned in a housing or carrier that is attached, either directly or indirectly, to one or more bands or other elements that include hook-and-loop material (such as Velcro® for example) so that the band or other element can be repeatedly attached to, and detached from, cargo or a cargo carrier. For example, the band may be removably attached to a front post of a bicycle, or to a cargo net and/or cargo rack positioned on top of a vehicle.

In another example, the sensor 22 may be positioned in a housing that includes a magnet for attachment of the sensor 22 and associated housing to a steel portion of cargo or a steel cargo carrier. In a related example, a pair of magnets may be supplied where one magnet is attached to the housing or other structure that is positioned, for example, on the outside of a soft cargo carrier, and another magnet is positioned on the inside of the soft cargo carrier. The sensor is then substantially maintained in position by the mutual attraction between the two magnets.

In a further example, the sensor 22 may be positioned in a housing that can be removably attached to a bracket or similar structure configured to be permanently, or detachably, attached to cargo and/or a cargo carrier.

In yet other example embodiments, the sensor 22 and/or any other sensor disclosed herein, can remain attached to the cargo carrier or cargo by way of, for example, a track or other structure so that the sensor 22 position can be changed without removing the sensor 22 from the cargo carrier or cargo. In a related example embodiment, the sensor 22 and/or any other sensor disclosed herein is attached to the cargo or cargo carrier by way of a tether or comparable device. One useful aspect of these particular example embodiments is that because the sensor 22 is configured to be repositioned with respect to a portion of the cargo or cargo carrier, but not readily removed from the cargo or cargo carrier, the likelihood that the sensor 22 would be lost during repositioning is substantially eliminated. Of course, the scope of the invention is not limited to these examples and, instead, extends to any other arrangement where one or more sensors, such as sensor 22 for example, can be repositioned with respect to a portion of the cargo or cargo carrier, while remaining attached to the cargo or cargo carrier. In these examples, and others disclosed herein, moreover, the sensor 22 and/or any structure that it is attached to or positioned in, such as a housing for example, can be attached either directly or indirectly to the cargo or cargo carrier.

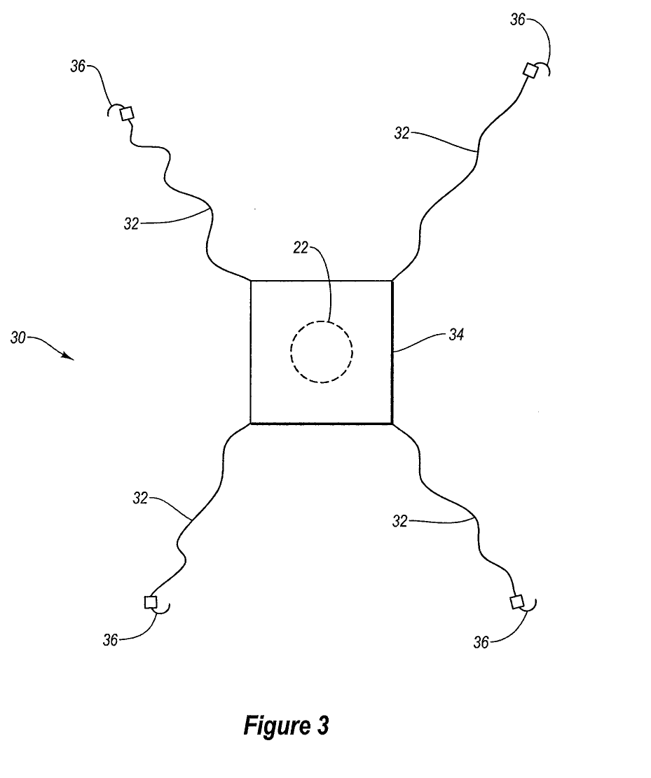

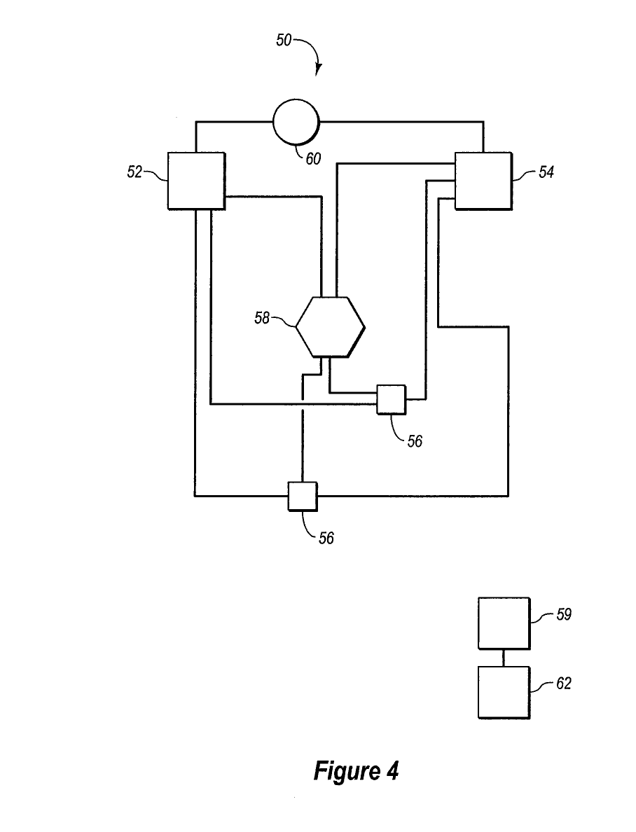

In still another example, aspects of which are disclosed in FIG. 3, the sensor 22 may be positioned in a housing (not shown) that is removably or permanently attached, either directly or indirectly, to a sensor harness 30 that includes one or more adjustable elements 32, such as bungee cords, elastic bands, or adjustable buckle straps for example, that can be stretched or otherwise manipulated, reconfigured or modified to accommodate a variety of different physical cargo and/or cargo carrier configurations. In the example of FIG. 3, the sensor harness 30 includes a carrier 34 configured to carry a sensor, such as sensor 22. In this example, one or more of the adjustable element(s) 32 of the sensor harness 30 may be attached to, or otherwise include, hooks, clamps or any other type of attachment elements 36 so that the adjustable elements 32 can be releasably secured to cargo and/or a cargo carrier in a desired fashion, thereby enabling the positioning of a sensor, such as sensor 22, in a desired location with respect to the cargo and/or cargo carrier.

It should be noted with respect to the foregoing examples that, as used herein, the term “housing” is intended to be construed broadly and embraces any structure(s) or device(s) capable of holding the sensor. The housing may incorporate a variety of attributes. Thus, in some examples, the housing may be substantially watertight. The housing may include a window comprising plastic or other substantially optically transparent material. The window may comprise a shatter-resistant material. The housing may also be configured in such a way that the sensor can be removed from the housing and/or replaced. The housing can comprise rubber, plastic, metal and/or a combination of these and/or other materials. In some cases, the housing may comprise a multi-part configuration such that the housing can be partially or completely disassembled to allow access to the sensor and/or to permit attachment or detachment of the housing to/from a cargo carrier or cargo. Additionally, the housing can be aerodynamically shaped and/or may be configured in such a way that impacts with insects, dust and dirt are minimized. The housing may contain a portion, or all, of the sensor.

The aforementioned, and/or other, attributes may be implemented in any desired combination in a particular housing. In some embodiments, the housing and sensor can be positioned in a carrier, as disclosed elsewhere herein. In further embodiments, a housing may be omitted. In still other embodiments, elements such as attachment elements 36 for example, may be attached to the housing.

As illustrated by the aforementioned examples, the sensor system 20 can be readily reconfigured to suit cargo and cargo carriers of various sizes and/or configurations. Thus, for example, a vehicle operator can position the sensor on a bicycle that is mounted to the cargo carrier and, later, when the bicycle is removed and a kayak attached, the sensor can be removed from the bicycle and attached to the kayak. In this way, the functionality of the sensor system can be redeployed quickly and easily to suit changes in the configurations of the cargo and/or cargo carrier. Thus, the cargo sensor can be selectively located in various desired locations and with respect to various elements such as vehicles, cargo and cargo carriers.

As disclosed herein, there are a variety of ways that a sensor may be temporarily positioned with respect to, and secured to, cargo or a cargo carrier. Accordingly, the foregoing, and other examples disclosed herein, thus comprise examples of structural implementations of a means for selectively locating the sensor. Of course, any other structure(s) of comparable functionality may likewise be employed, and are contemplated as being within the scope of the invention.

In some related example embodiments, the sensor 22 may be positioned in a housing that can initially be positioned in any desired location but that, once positioned, is not easily removed from that location. For example, one embodiment includes a sensor 22 having an associated housing that includes an adhesive element, such as a peel-and-stick portion having pressure-sensitive adhesive, such that the housing can be positioned, at least one time, in any particular desired location by pressing the adhesive element of the housing onto the cargo or cargo carrier, such as on the front post of a bicycle, or the bow of a canoe, for example. In another example, the housing within which the sensor is positioned can be configured of, or otherwise include, material(s) that can be permanently attached, such as by the use of an adhesive, to cargo or a cargo carrier. In one particular example, the housing can be attached to cargo or a cargo carrier with the use of epoxy.

In still another example, the housing or other structure may include, or be usable with, fasteners, such as screws or bolts for example, that enable the housing to be securely attached to the cargo or cargo carrier. The fasteners may be configured and employed in some embodiments so as to enable permanent attachment of the housing to cargo or a cargo carrier, and in other embodiments to enable selective relocation of the housing with respect to a portion of the cargo or cargo carrier. As but one particular example, the housing, or other structure for retaining the sensor, may include one or more openings through which a nail or screw can be passed. By hammering the nail, or driving the screw, through the opening and into cargo such as building materials, the housing and, thus, the sensor, can be retained in position. The housing can then be removed from the cargo after use by removal of the fasteners.

In another example embodiment, the housing itself includes a screw such that the housing can be attached to a cargo material, such as wood for example, by simply pushing on the housing and rotating the housing so that the screw advances into the cargo material. The housing can be subsequently removed from the cargo material by performing this process in reverse. Both attachment and detachment of the housing in this fashion can be performed before, while, or after, the cargo is positioned on a vehicle rooftop.

In a related example, a housing may include a first complementary element of a quick-release connection, while the cargo includes a second complementary element of the quick release connection. One example of such a quick-release connection is sometimes referred to as a ‘bayonet’ mount, although any other quick-release connection may be employed. In some cases, the housing can be releasably locked to the second complementary element by rotating the housing 90 degrees relative to the complementary portion. The second complementary element may, or may not, be permanently affixed to the cargo.

Embodiments of the invention can also be produced in an ‘after-market’ configuration in the event a user purchases a cargo carrier without an integral sensor. In one example of such a configuration, a sensor, such as the sensor 22, and/or associated housing may be provided with suitable hardware, such as mounting brackets, fasteners and/or other items suitable for use in attaching the sensor to the cargo carrier.

As suggested above, some example embodiments are directed to cargo carriers that may include one or more integral sensors configured such that the position of the sensor(s), when deployed in the cargo carrier, is/are substantially fixed with respect to the cargo carrier. In examples such as these, the location of the sensor with respect to the cargo carrier generally does not change except for instances such as those where the sensor is removed from the cargo carrier for maintenance, replacement, or other reasons.

### II. Example Sensor System

With continued attention to FIGS. 1a and 1b and directing attention now to FIG. 4, aspects of some example sensors such as may be used in connection with embodiments of the invention will now be discussed in further detail. In general, example embodiments of the sensors are robust enough to provide reliable operation even during extreme hot and cold temperatures. As well, at least some embodiments of the sensors should be capable of reliable operation notwithstanding the presence of dust, dirt, insects, rain, snow, mud and other conditions that can be encountered during vehicle operation.

Any type of sensor, such as a proximity sensor for example, that is capable of identifying the presence of an obstruction and transmitting a corresponding signal can be employed. Moreover, the aforementioned functionalities can be split between a plurality of different circuits or devices if desired. In at least some example embodiments, the sensor is implemented as a transceiver such that the sensor is capable of transmitting a detection signal, receiving a corresponding input signal and, if necessary, transmitting a warning signal to one or more remote indicators. This is only one example however, and the scope of the invention is not limited to transceivers.

The detection and/or input signals may take a variety of forms including, but are not limited to, optical, acoustic, electromagnetic, radio, infrared, ultrasonic, microwave, low energy radar, or other, forms. In at least some embodiments, the input signal comprises a reflected portion of the detection signal. More generally, any detection and/or input signals suitable for implementing aspects of the functionality disclosed herein can be employed, and the scope of the invention is not limited to any particular type(s) of such signals.

In FIG. 4, a sensor system 50 is disclosed that includes one or more sensors 52 and 54 that may be located, with respect to cargo and/or a cargo carrier (not shown), as desired. The sensors 52 and 54 may be associated with one or more remote indicators 56. In general, the type, number, location and orientation of the remote indicators 56 and the sensors 52 and 54 may be varied as desired. In the illustrated example, the sensor system 50 is powered by a power supply 58 that may comprise a dedicated power supply, or the electrical system of an associated vehicle. In at least one alternative embodiment, the sensors 52 and 54 may be solar powered.

In one embodiment of the sensor system 50, each sensor 52 and 54 interacts only with a particular corresponding remote indicator 56. In another embodiment, each sensor 52 and 54 interacts with all remote indicators 56. In yet another embodiment, each sensor 52 and 54 interacts with a predetermined group of one or more remote indicators 56 that may be less than the total number of remote indicators employed. More generally, one or more sensors may be employed that are configured to interact with one or more remote indicators in any of a variety of different combinations.

With respect to their location relative to the vehicle, the remote indicators 56 may generally be located so as to generate an indication when one or more of the sensors 52 and 54 detect an obstruction relative to cargo associated with the vehicle. In at least some embodiments, the remote indicators 56 can be located in the interior of a vehicle, such as in an area perceptible by a vehicle operator. As indicated in FIG. 4, the remote indicators 56 may be powered by the power supply 58. In some embodiments, the remote indicators 56 and the sensors 52/54 may have different respective power supplies. In at least one embodiment, discussed in further detail below, one or more sensors 52 and 54 may be configured for use and operation in connection with other vehicle components 60, such as the speedometer for example. The various components of the sensor system 50 may communicate with each other directly and/or in connection with a control module, as discussed below.

In yet another example, the sensor system 50 may include a control module 59 that controls communication and interaction between and among the various elements of the sensor system 50. The control module 59 may be programmable and may communicate either wirelessly, via one or more hardwired connections, or via optical communication media such as an optical fiber, with the other elements of the sensor system 50. Such wireless communications extend to, for example, radiofrequency (RF) communications. Additionally, the control module 59 may include a dedicated power supply, or may draw power from an associated vehicle electrical system. The control module 59 may include processors, memory elements, communication interfaces and other elements for implementing the foregoing, and other, functionalities. As further disclosed in FIG. 4, and elsewhere herein, a user interface 62 may be employed to enable user interaction with the sensor system 50. Such interactions may include, for example, programming and control of the sensor system 50, as well as receipt of information, by the user, concerning the status and/or operation of the sensor system 50.

One or more sensors 52 and/or 54 can communicate with one or more remote indicators 56 in any suitable manner. For example, the sensors 52 and 54 can communicate with the remote indicators 56 wirelessly, via a hard-wire connection, via an optical fiber connection, or via any other suitable communication type or medium. With respect to wireless communication, any suitable wireless communication can be employed. In one example, the sensors 52 and 54 can communicate wirelessly with the remote indicators 56 in accordance with the standards, requirements and protocols set forth in the IEEE 802.11 requirements. Of course, the scope of the invention is not limited to any particular method or mode of communication between the sensors 52 and 54, and the remote indicators 56.

In operation, one or more of the sensors 52 and 54 transmits a detection signal to determine whether or not an obstruction is present that could present a threat of damage to rooftop cargo with which the sensors 52 and 54 are associated. The sensor system 50 may be configured so that the detection signal is transmitted at particular times and/or when particular conditions are satisfied. For example, the sensor system 50 may be configured so that the detection signal is transmitted only when the associated vehicle is traveling below certain speeds. As another example, the detection signal may be transmitted only so long as one or more particular conditions remains satisfied, such as while the speed of the vehicle remains at or below 5 miles per hour, for example. Further, the detection signal may be transmitted intermittently or continuously, depending upon the requirements of the application. As well, the sensor system 50 may be configured to be manually enabled and disabled, and such a configuration would provide, among other things, a measure of control over the transmission of the detection signal. In yet another example, a vehicle operator or other personnel can employ a user interface to change the sensor system 50 from a ‘sleep’ mode, where no detection signal is generated or transmitted, to an ‘active’ mode where the detection signal is generated and transmitted. It should be noted that aspects of the aforementioned examples may be combined together to define yet further embodiments and the aforementioned examples are not intended to be mutually exclusive.

If an input signal, which may take the form of reflected energy from the detection signal, indicates to the sensors 52 and/or 54 that an obstacle is present, the sensors 52 and/or 54 transmits a corresponding obstacle signal to one or more of the remote indicators 56. Responsive to receipt of the obstacle signal from the sensors 52 and/or 54, one or more of the remote indicators 56 then provides a warning signal to warn the vehicle operator that an obstacle has been detected by the sensors 52 and/or 54. The obstacle signal can be generated and/or transmitted according to various criteria. By way of example, the obstacle signal may be triggered upon determination that an obstacle is present and may continue to be asserted until such time as the obstacle is beyond the range of the sensor system 50. The sensor system 50 may be configured so that assertion of the obstacle signal can be manually halted by a vehicle operator. Such functionality may prove useful where the obstacle signal was erroneously asserted due to a sensor system 50 error or due, for example, to one or more of the sensors 52 and/or 54 having been set with too great a degree of sensitivity. In another example, the obstacle signal may be triggered upon determination that an obstacle is present and may continue to be asserted until a sensor system 50 operator disables the sensor system 50, overrides the assertion of the obstacle signal, resets the sensor system 50, or puts the sensor system 50 into a ‘sleep’ mode. In some examples, resetting the sensor system 50 may comprise changing the system from the ‘active’ mode to the ‘sleep’ mode.

As the foregoing examples make clear, the sensor system 50 can be configured so that in some instances at least, deassertion of the obstacle signal is a passive step that does not require affirmative operator intervention, while in other instances, deassertion of the obstacle signal only occurs in response to affirmative intervention by the sensor system 50 operator. Both of these operating modes may be incorporated into a single sensor system 50.

In some embodiments, the remote indicators 56 provide only a warning signal while, in other embodiments, the remote indicators 56 provide additional status information. In one example of the latter case, the remote indicator 56 may be implemented as a dual color device where the remote indicator 56 displays green so long as no obstacle is detected, and then displays red when an obstacle is detected.

Further information concerning the detection, input, obstacle and warning signals and associated sensors and remote indicators is provided below. It should be noted that it is contemplated that any of the various aspects disclosed herein of the remote indicators, sensors, other sensor system components, signals, and operating parameters may be combined as desired to define and implement a sensor system having desired components and structural and operational features.

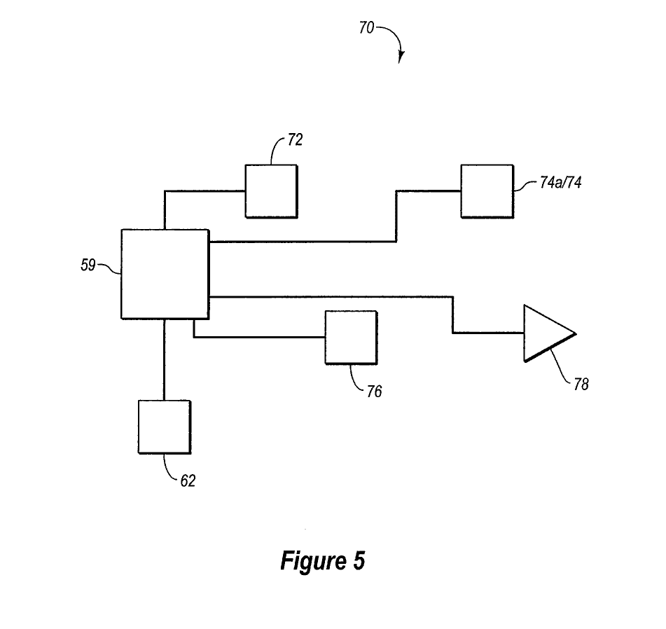

Finally, and as noted elsewhere herein, at least some embodiments of the sensor system include some form of user interface 62 (see FIGS. 4 and 5) so as to enable a user to interact with the sensor system. The user interface may be as simple as a keypad, for example, that is connected with the control module, and that allows a user to control and/or program the sensor system through the use of a series of numeric or alphanumeric codes.

In more complex systems, the user interface may take the form of a screen, such as a touchscreen for example, that can provide comprehensive information, in visual and/or audible form, to the user concerning the configuration, programming, operation and status of the sensor system. Thus, the user interface may allow a user to, among other things, interact with some or all of the sensor system by visual, tactile and/or audible modes to configure, operate, and control the sensor system.

### III. Example Sensors

With attention now to FIG. 5, further information is now provided concerning some aspects of the nature and operation of examples of sensors and associated circuits that may be employed in connection with embodiments of the invention. While presented in terms of sensor characteristics, it is noted that the following is a list of aspects that may be incorporated in one or more embodiments of sensors and/or sensor systems. Such aspects include, but are not limited to the following:
the sensors may transmit a warning signal wirelessly, or via hardwire, to a display and/or other remote indicator(s) inside vehicle;
multiple sensors may be employed that each have a corresponding remote indicator inside the associated vehicle—in one example, four remote indicators are provided in the form of light bulbs, light emitting diodes (LED), or other visual indicators labeled “Front,” “Rear,” “Left Side,” and “Right Side”;
one or more sensors may be battery operated, or inductively coupled, or may draw energy from a vehicle electrical system;
the sensors and/or sensor system may be configured so as to be disabled when no cargo and/or cargo carrier is present;
the sensors and/or sensor system may be activated automatically, such as when the vehicle is started for example, or when the vehicle is placed in gear (whether forward or reverse);
the sensors may be configured for manual and/or automatic activation;
the sensors and/or sensor system may be programmable—either directly or remotely, such as by a user interface for example, where the user interface may include a user input device and a display;
the sensors and/or sensor system may be activated remotely—e.g., from inside or outside the vehicle
the sensors may be customizable, such as by programming, to a particular vehicle so that errant signals from other vehicles would not affect the operation of those sensors—the customizability may be implemented by the use of user codes or passwords, for example;
the sensors may incorporate an adjustable sensitivity and/or activation thresholds—in one example illustrative of this concept, the sensitivity of the sensors can be adjusted so that the sensors would not transmit an obstacle signal if a small tree branch was detected by the sensors, while the presence of a suitably large tree branch would result in the generation of an obstacle signal;
the sensors may be configured so that their operation would not interfere with Bluetooth or 802.11 networks or other vehicle systems and electronics;
the sensors may have an associated remote control for operation, programming and other purposes;
the sensors may be speed sensitive, so that a relatively fast approach towards a garage or other obstruction, for example, would not impair or affect operation of the sensor;
the sensors may include a low battery warning function that would cause an indication in the vehicle or elsewhere to warn that a battery power source to the sensor was running low;
the sensors may include simple diagnostics to identify operational problems, such as if the sensor is malfunctioning;
the sensor may be configured to shut down or ‘sleep’ at speeds above a particular miles per hour threshold—in one example illustrative of this concept, a maximum parking speed for a vehicle may be 5 mph or less, so the sensor may be configured to remain in a ‘sleep’ mode until the speed drops below that level, at which point the sensor would transition to a ‘wake’ mode.
   It should be noted that the foregoing are example aspects of various sensors and are not intended to limit the scope of the invention in any way. Moreover, it will be apparent to one of ordinary skill in the art that various commercially available sensors may be employed in connection with embodiments of the invention.

### IV. Example Remote Indicators

With continued attention to FIGS. 1 and 2, further information is now provided concerning aspects of the nature and operation of examples of remote indicators that may be employed in connection with embodiments of the invention. Such example remote indicators may incorporate one, some, or all of the following aspects:
the remote indicators inside vehicle may be audible, visual, or both, or synthesized warning voice;
the remote indicators may transmit specific information—for example, the number of feet to collision;
the remote indicators may transmit progressively urgent remote indicators—for example, the number of beeps in set time frame relates to proximity such that relatively more beeps in a particular time frame means that an obstacle is closer or becoming closer;
the remote indicators can be located in any desired place relative to the vehicle, such as the dashboard, driver console, or elsewhere, so that warning signals associated with the remote indicators can be perceived by the vehicle operator; and
one or more remote indicators may also be located on the exterior of the vehicle so that warning signals associated with the remote indicators can be perceived by the vehicle operator and/or by personnel outside of the vehicle.
   It should be noted that the foregoing are example aspects of various indicators and are not intended to limit the scope of the invention in any way. Moreover, it will be apparent to one of ordinary skill in the art that various commercially available indicators may be employed in connection with embodiments of the invention.

As indicated in FIG. 5, one example sensor system 70 may include a detection signal generation circuit 72, an input signal reception circuit 74 and associated detector 74a configured to receive an input signal that comprises a reflected portion of a detection signal, an obstacle signal generation circuit 76, and a wireless communication interface 78. One or more of these elements may communicate with each other directly and/or by way of the control module 59. It should also be noted with respect to the examples of FIGS. 4 and 5 that the disclosed circuits and devices may be implemented together in a variety of different ways and different combinations. Accordingly, the functionalities associated with the circuits and devices disclosed herein can be allocated amongst those circuits and devices in any suitable manner and the scope of the invention should not be construed to be limited to the example functional allocations disclosed herein. By way of illustration only, one embodiment of a sensor may include a detector, detection signal circuit, an input signal reception circuit configured to receive an input signal that comprises a reflected portion of a detection signal, an obstacle signal generation circuit, and a wireless communication interface. In another example embodiment, the wireless communication interface may be omitted from the sensor and included in a control module with which the sensor communicates by a hardwire connection. Thus, in this alternative example, the wireless communication functionality is implemented in the control module, rather than in the sensor.

### V. Computing Environments, Hardware and Software

In at least some cases, some or all of the functionality disclosed herein may be implemented in connection with various combinations of computer hardware and software. With respect to computing environments and related components, at least some embodiments of the present invention may be implemented in connection with a special purpose or general purpose computer that is adapted for use in connection with client-server operating environments. Embodiments within the scope of the present invention also include computer-readable media for carrying or having computer-executable instructions or electronic content structures stored thereon, and these terms are defined to extend to any such media or instructions.

By way of example such computer-readable media can comprise RAM, ROM, EEPROM, CD-ROM or other optical disk storage, magnetic disk storage or other magnetic storage devices, or any other medium which can be used to carry or store desired program code in the form of computer-executable instructions or electronic content structures and which can be accessed by a general purpose or special purpose computer, or other computing device.

When information is transferred or provided over a network or another communications connection (either hardwired, wireless, optical, or a combination of any of the foregoing) to a computer or computing device, the computer or computing device properly views the connection as a computer-readable medium. Thus, any such connection is properly termed a computer-readable medium. Combinations of the above are also to be included within the scope of computer-readable media. Computer-executable instructions comprise, for example, instructions and content which cause a general purpose computer, special purpose computer, special purpose processing device such as a processing device, controller, or control module associated with a sensor system, or other computing device, to perform a certain function or group of functions.

Although not required, aspects of some embodiments of the invention have been described herein in the general context of computer-executable instructions, such as program modules, being executed by computers in network environments. Generally, program modules include routines, programs, objects, components, and content structures that perform particular tasks or implement particular abstract content types. Computer-executable instructions, associated content structures, and program modules represent examples of program code for executing aspects of the methods disclosed herein.

The disclosed embodiments are to be considered in all respects only as example and not restrictive. The scope of the invention is, therefore, indicated by the appended claims rather than by the foregoing description. All changes which come within the meaning and range of equivalency of the claims are to be embraced within their scope.

What is claimed is:

1. A cargo carrier sensor system, comprising:
a sensor including:
a detection signal generation circuit;
an input signal reception circuit configured to receive an input signal that comprises a reflected portion of a detection signal; and
an obstacle signal generation circuit connected with the input signal reception circuit;
a wireless communication interface connected with the obstacle signal generation circuit; and
means for selectively locating the sensor, the means for selectively locating the sensor enabling the sensor to be desirably located with respect to a vehicle cargo carrier.

2. The cargo carrier sensor system as recited in claim 1, wherein the means for selectively locating the sensor enables the sensor to be placed in a desired position with respect to cargo located on a vehicle rooftop.

3. The cargo carrier sensor system as recited in claim 1, wherein the means for selectively locating the sensor enables the sensor to be placed in a first desired location and subsequently relocated to a second desired location.

4. The cargo carrier sensor system as recited in claim 1, wherein the sensor is configured to be programmed by a user.

5. The cargo carrier sensor system as recited in claim 1, wherein the sensor is configured for wireless communication with another component.

6. The cargo carrier sensor system as recited in claim 1, wherein a sensitivity of the sensor is adjustable.

7. The cargo carrier sensor system as recited in claim 1, wherein the means for selectively locating the sensor comprises a housing.

8. The cargo carrier system as recited in claim 7, wherein the housing is configured to be attached to cargo or a cargo carrier with one or more fasteners.

9. The cargo carrier system as recited in claim 7, wherein the means for selectively locating the sensor further comprises one or more adjustable elements attached at least indirectly to the housing, one or more of the adjustable elements being configured to be removably attached to a cargo carrier or cargo.

10. A cargo transportation system, comprising:
a cargo carrier configured to be attached proximate a roof of a motor vehicle; and
a sensor attached proximate one end of the cargo carrier, the sensor comprising:
a detection signal generation circuit;
an input signal reception circuit configured to receive an input signal that comprises a reflected portion of a detection signal;
an obstacle signal generation circuit connected with the input signal reception circuit; and
a wireless communication interface connected with the obstacle signal generation circuit.

11. The cargo transportation system as recited in claim 10, wherein the sensor is movable with respect to the cargo carrier.

12. The cargo carrier transportation system as recited in claim 10, wherein the cargo carrier is configured to be removably attached proximate a roof of a motor vehicle.

13. The cargo carrier system as recited in claim 10, further comprising a housing within which a portion of the sensor is disposed.

14. The cargo carrier system as recited in claim 13, wherein the housing is removably attachable to the cargo carrier.

15. The cargo carrier system as recited in claim 13, wherein the housing is movable relative to the cargo carrier.

16. A sensor system, comprising:
a sensor;
means for selectively locating the sensor, the means for selectively locating the sensor enabling the sensor to be desirably located with respect to a vehicle cargo carrier;
a remote indicator configured for wireless communication with the sensor;
a user interface configured for communication with the sensor;

17. A vehicle, comprising:
a body at least partially defining a rooftop;
a cargo carrier mounted proximate the rooftop of the vehicle; and
the sensor system as recited in claim 16, the sensor being attached at least indirectly to the cargo carrier.

18. The vehicle as recited in claim 17, wherein the sensor is movable relative to the vehicle.

19. The sensor system as recited in claim 16, wherein the sensor is programmable by way of the user interface.

20. The sensor system as recited in claim 16, wherein the remote indicator is responsive to an obstacle signal generated by the sensor such that generation of the obstacle signal corresponds to generation of an indication by the remote indicator, the indication being perceptible by a vehicle operator.
